(19) United States
(12) Patent Application Publication
(10) Pub. No.: US 2008/0202108 A1
(43) Pub. Date: Aug. 28, 2008

(54) Reductant supply system for a waste gas cleaning catalyst of an internal combustion engine and a plug-in connection for connecting heatable fluid ducts

(76) Inventors: Jurgen Stritzinger, Freckenfeld (DE); Gerhard Thome, Kronau (DE); Roland Starck, Bellheim (DE); Armia Lang, Barbelroth (DE); Lutz Ziegler, Landau (DE); Markus Niklasch, Forst (DE)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 12/072,436

(22) Filed: Feb. 26, 2008

(30) Foreign Application Priority Data
Feb. 27, 2007 (DE) 10 2007 009 348.0
Jun. 4, 2007 (DE) 10 2007 026 205.3

(51) Int. Cl. F01N 3/24; H05B 3/06

(52) U.S. Cl. 60/301; 60/295; 219/541

(57) ABSTRACT

The invention relates to a reductant supply system for a waste gas cleaning catalyst (1) of an internal combustion engine, particularly a motor vehicle, comprising a reductant tank (3) for the storage of reductants, at least one electrically heatable fluid duct (6, 8) for the conveyance of reductant from the reductant tank (3) to a waste gas cleaning catalyst (1), a pump (5) to pump the reductant via the fluid duct (6, 8) from the reductant tank (3) to the waste gas cleaning catalyst (1), and a plug-in connection (10, 11) for connecting sections of the fluid duct (6, 8) in a fluid-conveying manner and/or connecting the fluid duct in a fluid-conveying manner to a component of the reductant supply system, wherein the plug-in connection additionally forms an electric connection line (12, 13, 14) which in operation conveys an electrical heating current for heating of the fluid duct (6, 8).

The invention relates also to a plug-in connection (10, 11) for connecting a heatable fluid duct section (8a, 8b) as well as a female (10) and a male connector (11) of such plug-in connection.

The invention relates to a reductant supply system for a waste gas cleaning catalyst, such catalyst being a standard feature in motor vehicles. Such a reductant supply system comprises a reductant tank, an electrically heatable fluid duct and a pump to pump the reductant via the fluid duct from the reductant tank to the catalyst. By way of example, such a reductant supply system is known from DE 10 2005 029 290 A1.

Within the present application, pursuant to the customary language in motor vehicle technology, the term waste gas cleaning catalyst is used for a device for waste gas cleaning that comprises a catalyst within the chemical sense. Such waste gas cleaning catalysts are installed as standard features in motor vehicles. As a rule, the reductant is added to a waste gas flow before it reaches the area of the waste gas cleaning catalyst which comprises the catalyst within the chemical sense.

In the waste gas cleaning catalyst nitrogen oxides are reduced to nitrogen by means of the reductant. Ammonia, which is obtained from urea, is usually used as reductant within the original meaning. Therefore, within present application reductant also comprises any initial product, e.g., urea, from which is obtained the actual reductant within the chemical sense, e.g., ammonia.

In the case of frost, the urea solution required by the waste gas cleaning catalyst as ammonia supply can freeze. Therefore, electrically heatable fluid ducts are used for reductant supply systems so that, even in the case of severe frost, the urea solution can be readily pumped to the catalyst.

Because the decomposition products of urea are corrosive, at least the surfaces of the fluid-conveying components of the reductant supply system must be made of corrosion resistant materials. Even slight leakage points could bring about a failure of the reductant supply system and cause damage to the motor vehicle. Moreover, even small amounts of urea and its decomposition products cause an unpleasant odor.

The object of the invention is to show a cost-efficient manner in which a vehicle can be equipped with a reductant supply system that, in the case of frost, facilitates as promptly as possible a supply to the waste gas cleaning catalyst, satisfies the highest requirements for imperviousness and can be installed as easily as possible.

This object is solved by a reductant supply system with the features set forth in claim 1.

By means of the invention, the installation of the electrically heatable fluid ducts of reductant supply systems is considerably simplified. While it is rather cumbersome to handle rather lengthy one-piece fluid ducts, a fluid duct according to the invention may consist of easily manageable duct sections that can be easily assembled by means of male and female plug-in connectors. The plug-in connection of a reductant supply system, according to the invention, also forms an electric connection line that, during operation, conveys a heating current for the heating of the assembled fluid duct sections. Thus, with it is possible to connect fluid duct sections in a fluid-conveying manner and, concomitantly, to realize an electric connection for the fluid duct heating.

In addition to connecting sections of the fluid duct of a reductant supply system in a fluid-conveying manner, a plug-in connection according to the invention can also be used to connect the fluid duct in a fluid-conveying manner to a component of the reductant supply system, whereby the plug-in connection also configures an electric connection line that, during operation, conveys a heating current for the heating of the fluid duct. Thus, the fluid duct can be connected with very little expenditure to the pump or to any other component of the reductant supply system, e.g., a tank or a metering valve.

Preferably, the plug-in connection, in particular the female part of the plug-in connection, is electrically heatable, e.g., in that the electric connection line is designed for resistance heating.

The invention also relates to a plug-in connection, in particular for motor vehicles, for connecting a heatable fluid duct section, e.g., to a pump or to another fluid duct section, as well as male connector of such a plug-in connection and a a female connector.

### BRIEF DESCRIPTION OF THE DRAWINGS

Further details and advantages of the invention are explained by means of embodiments with reference to the accompanying drawings. The therein explained features can be made objects of claims. Identical parts or parts corresponding to each other of the various embodiments are indicated in the drawings by the same reference numbers, wherein:

FIG. 1 shows a diagrammatic view of an embodiment of a urea supply system for a waste gas cleaning catalyst of a motor vehicle;

FIG. 2 shows an embodiment of a plug-in connection that connects two fluid duct sections of the reductant supply system;

FIG. 3 shows another embodiment of a plug-in connection; and

FIG. 4 shows yet another embodiment of a plug-in connection.

### DETAILED DESCRIPTION

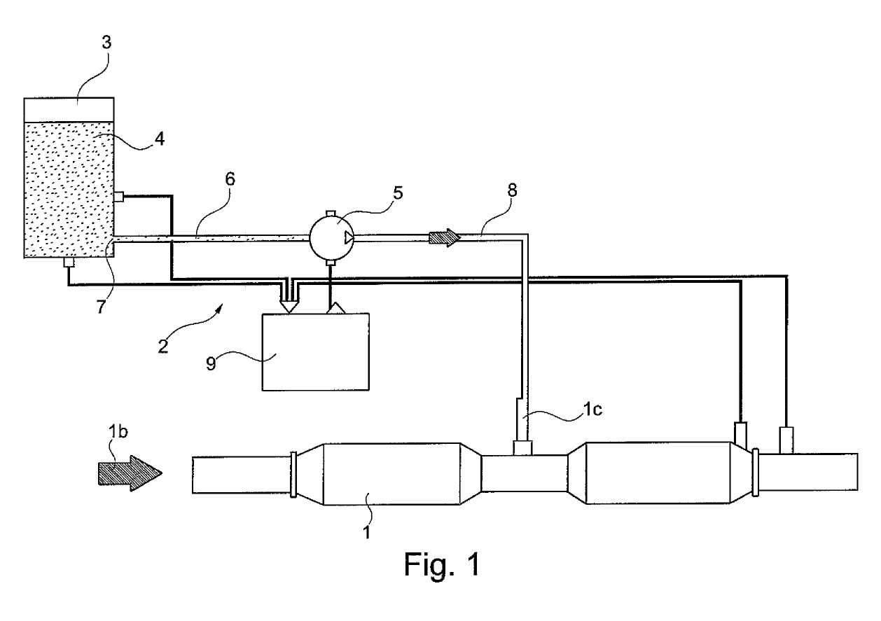

FIG. 1 shows in a diagrammatical view a waste gas cleaning catalyst 1 of a motor vehicle and a therewith associated reductant or urea supply system 2. Nitrogen oxides in the waste gas cleaning catalyst 1 are reduced to nitrogen by means of ammonia. The ammonia is obtained from urea solution that is provided by the urea supply system 2 and which is added to the waste gas flow 1b by means of the metering valve 1c to the catalyst 1.

The urea supply system 2 illustrated in FIG. 1 comprises a reductant tank 3 for the storing of the urea solution 4, an electrically heatable fluid duct 6, 8 for the conveying of the reductant from the reductant tank 3 to the waste gas cleaning catalyst 1, and a pump 5 for the pumping of the reductant from an outlet 7 of the reductant tank 3 through the fluid ducts 6, 8 to the catalyst 1.

The pump 5 and the catalyst 1 are controlled by a control unit 9 that, in the case of frost, turns on an electric heating of the reductant tank 3, the pump 5 and the fluid ducts 6, 8. Preferably, the pump 5 is arranged adjacent to the tank 3 so that the duct section 6 can be so short that it can be sufficiently heated by a tank and/or pump heating system so that an inherent heating of the short duct section 6 can be dispensed with.

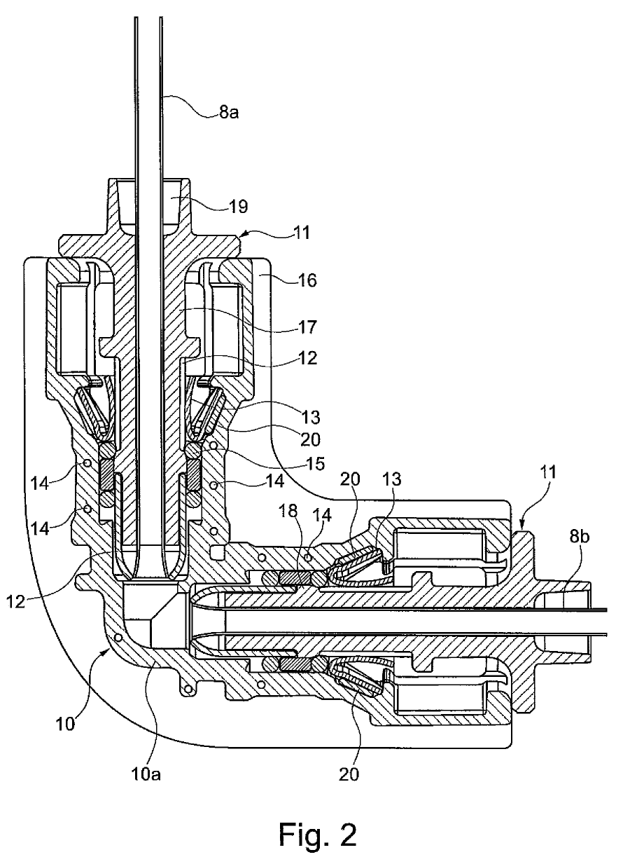

As shown in FIG. 2, the fluid duct 8 is assembled by several duct sections 8a, 8b that are connected in a fluid-conveying manner by a plug-in connection 10, 11, shown in FIG. 2. The plug-in connection 10, 11 additionally constitutes an electric connection line that, during operation, conveys a heating current for the heating of the assembled fluid duct sections 8a, 8b. In the illustrated embodiment the electric connection line comprises the components 12, 13 and 14 that will be explained hereinafter in more details.

The connected sections 8a, 8b of the fluid duct 8 are made out of corrosion-resistant metal pipes, preferably out of stainless steel, e.g., out of V4A steel, that contact the electric connection line 12, 13, 14 of the plug-in connection 10, 11. A voltage is applied between the ends of the fluid duct 8 for the heating, so that an electric current flows through the metal pipes. The metal pipes of the fluid duct 8 are heated by the electric current flowing through them and are thus used as resistance heating elements. Moreover, the connection line 12, 13, 14 of the plug-in connection connects electrically the two fluid duct sections 8a, 8b, so that the two fluid duct sections 8a, 8b are electrically connected in series. This has the advantage that the heating can be very easily monitored. However, it is also possible to use the connection line 12, 13, 14 of the plug-in connection as a voltage terminal and to connect to ground the ends of the fluid duct sections opposite of the plug-in connection.

It is especially advantageous to configure at least a section of the connecting line formed by the plug-in connection as a resistance heating element, thus facilitating also a heating of the plug-in connection. This will be explained hereinafter in more details.

In such a manner, in the illustrated reductant supply system, a heating system is integrated into the fluid duct 8, facilitating heating throughout.

The plug-in connection 10, 11 comprises a female connector 10 with a plastic body 10a into which is inserted a male connector 11 of the plug-in connection. The female connector 10 of the embodiment illustrated in FIG. 2 is configured at two ends for insertion of a male connector 11. This measure has the advantage that a male connector 11 of the plug-in connection can be attached at each end of the fluid duct sections 8a, 8b to be connected, so that for the assembling it is possible to connect any end of the fluid duct sections 8a, 8b to a female connector 10. In this way it is also possible to configure the female connector 10 for insertion of three or more male connectors 11, e.g., to form a socket T with three connecting pieces 11 or a crosspiece with four connecting pieces 11.

The female connector 10 is provided with an electric contact 13 for the contacting of a current conductor 12 of the male connector 11 of the plug-in connection, whereby the contact 13 is connected to a section 14 of the electric connection line, carried by the plastic body 10a. During operation that section 14 conveys a heating current for the heating of the fluid duct sections 8a, 8b connected by the female connector 10.

In the illustrated embodiment, the electric contact 13 of the female connector 10 is provided by a metal spring-element made preferably out of stainless steel, especially V4A steel, that rests flexibly against the outside of an inserted male connector 11. This metal spring-element 13 serves also to lock an O-ring 15 and/or other sealing elements into position in the female connector 10. The outside of the spring element 13 rests against a metal ring 20, embedded or inserted into the female connector 10, which metal ring is electrically connected with the section 14. In such a manner, the male connector 11 can be inserted in whichever direction into the female connector 10 and cause an electric contact.

In the illustrated embodiment, the section 14 of the electric connection line is configured as a heating spiral 14, that is carried by the plastic body of the female connector 10, as it is embedded in it. In such a manner it is possible to convey, without any additional connecting lines, not only the heating current of the pipe 8 via the female connector 10 but also to concomitantly heat the female connector 10.

The plastic body 10a of the female connector 10 can be an injection molded part, which may be molded around a conveyance or heating element 14. Instead of a heating coil 14 other metal parts may be used such as, e.g., a lead frame or a perforated metal pipe. Instead of an embedding into the plastic body 10a, a conveyance or heating element 14 can also be wound, as a wire, around the plastic body 10a. Because in such embodiments the heating element 14 of the connecting line does not come into contact with urea solution, it is not necessary for the material to have a special corrosion resistance.

Another possibility to configure the conductor 14 carried by the plastic body 10a of the female connector 10 consists in using a synthetic material that, because of electrically conductive admixtures, e.g., graphite and/or metal particles, was made electrically conductive. In such a manner, the plastic body 10a of the female connector 10 can provide both the contact 13 as well as the conductor 14 of the connecting line. An electric insulation towards the outside may be achieved by means of a heat insulator 16, e.g., by a plastic sheathing that encases the female connector 10.

In the illustrated embodiment, the section 14 of the electric connection line, supported by the female connector 10, is configured as a resistance heating. In order to ensure in a motor vehicle a quick readiness for use of the reductant supply system, even in the case of very low outdoor temperatures, the resistance heating 14 of the female connector 10 should be configured for a heating power of at least 2 Watts, preferably at least 4 Watts. The heating coil 14 of the illustrated embodiment is configured for a heating power of 5 Watts. Therein, the heating of the plug-in connection 10, 11 and the heating of the fluid duct 6, 8 is effectuated by a series connection because in such a manner it is very easy to detect a defect of the heating for the reductant supply system 2 and, advantageously, no additional supply terminals are required.

The plug-in connection 10, 11, illustrated in FIG. 2, is encased by a heat insulator 16 so that the heating power of the heated fluid duct sections 8a, 8b and of the female connector 10 can be utilized as efficiently as possible. The heat insulator 16 can be configured as two half shells enclosing the female connector 10. Another possibility for the configuration of the heat insulator 16 consists in sheathing the female connector 10 with a heat-insulating synthetic material. Foam materials are particularly appropriate materials for the heat insulator 16. To attain a good heat insulation it is advantageous that the synthetic material used for the heat insulator 16 has a heat conduction of less than one half, especially less than ⅕, of the heat conduction of the fluid-conveying synthetic material of the female connector 10.

In case that the plug-in connection in a motor vehicle is installed in a location where much heat is generated during driving, e.g., near the catalyst, the heat insulator 16 can also serve as a heat shield and, in such a case, be provided with a ceramic coating.

In the illustrated embodiment, the male connector 11 of the plug-in connection is configured as a plastic body 17, slipped on the fluid duct section 8a, 8b. The body 17 carries at its front end a metal sleeve 12. The metal sleeve 12 on the outside of the male connector 11 constitutes an element of the electric connection line of the plug-in connection. This is particularly advantageous insofar as the metal sleeve 12 has an electrically conductive annular area and, therefore, in the case of whichever turning of the male connector 11 with respect to the female connector 10 it is possible to establish an electric contact.

In the illustrated embodiment, the metal sleeve 12, preferably made out of special steel, especially out of V4A steel, contacts the end of the fluid duct section 8a, 8b, configured as a metal pipe. It is especially advantageous to tightly connect the metal sleeve 12 to the end of the fluid duct section 8a, 8b. Especially appropriate for this are integral joints that can be attained by welding, preferably by laser welding. In such a manner it is attained that the heat current flows through the entire length of the fluid duct section 8a, 8b and that, thus, its entire length up to its outermost end is heated.

In the illustrated embodiment, the metal sleeve 12 is connected by a positive fit with the plastic element 17 of the male connector 11. In such a manner, it is prevented that the sleeve 12 could be displaced with respect to the plastic element 17. In the illustrated embodiment, the positive fit is attained by connection apertures in the sleeve 12 into which latches 18 of the synthetic element 17 grip. The metal sleeve 12 is preferably slotted at its rear end. This has the advantage that the metal sleeve spreads somewhat when slipped over the plastic element 17 so that it is easier to assemble the connecting piece 11.

The metal sleeve 12 can be used as a resistance heating element for the heating of the plug-in connection because it is also traversed by the heat current. For this it is advantageous if the electric contact area formed between the sleeve 12 and the female connector 10 is at a greater distance from the front end of the male connector 11, inserted in the female connector 10, than the contact area existing between the fluid duct section 8a, 8b and the sleeve 12. It is especially advantageous if, according to FIG. 2, the contact area between the metal sleeve 12 and the fluid duct section 8a, 8b is only at the front end of the male connector 11. It is especially advantageous to form the metal sleeve with a wall thickness that is not greater, preferably less, that the wall thickness of the steel pipe forming the fluid duct section 8a, 8b.

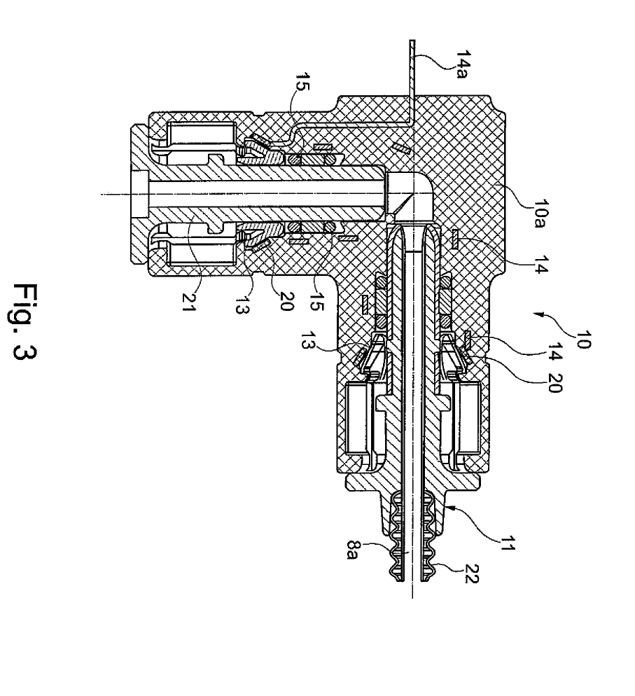

The male connector 11 of the plug-in connection is provided at its rear end with a pocket 19 for an insulation sheath 22, shown in FIG. 3, of the fluid duct section 8a, 8b. Polyamide or poly-phthaldiamid is particularly appropriate as material for the plastic body 10a of the female connector 10 and the plastic element 17 of the male connector 11 of the plug-in connection.

FIG. 3 shows another embodiment of a plug-in connection with a heatable female connector 10. The essential difference with the embodiment described in the example of FIG. 2 consists in that the female connector 10 receives only on one side a fluid duct section 8a with a male connector 11 of above-described type. Into the other slot of the female connector 10 is plugged a connector piece 21 that is not connected to an electric connection line and can, therefore, correspond in principle to a connecting piece known from prior art. By way of example, the connecting piece 21 can serve for connecting of the fluid duct to the metering valve 1c, to the pump 5 or to the tank 3.

The essential difference between the female connector 10 shown in FIG. 3 and the female connector 10 described in the example of FIG. 2 is that the electric connection line 14 is led from the female connector 10 to an outer peripheral area of the coupling. The section 14a of the connection line 14 protruding from the plastic body 10a of the female connector 10 can be used, e.g., to connect the heating system(s) of the fluid duct system to a power source. As the connecting piece 21 does not have any electric contact points, the spring element 13 on the corresponding side of the female connector 10 need not be out of metal but could be made as a cost-effective plastic element.

The coupling illustrated in FIG. 3 is heatable as the connection line 14 is configured as a resistance heating element. Similar to the embodiment illustrated in FIG. 2, the plastic body 10a of the female connector 10 is provided with a resistance hearing element 14 that can be configured, e.g., as a heating coil. This resistance heating element 14 is embedded in the plastic body 10a of the female connector 10. An advantage of the illustrated embodiment consists in that the connection line 14 facilitates in a simple manner an electrical connection for the heating of the fluid duct 8a. By means of section 14a of the connection line it is possible to connect the metal pipe constituting the fluid duct 8a to an electric power source.

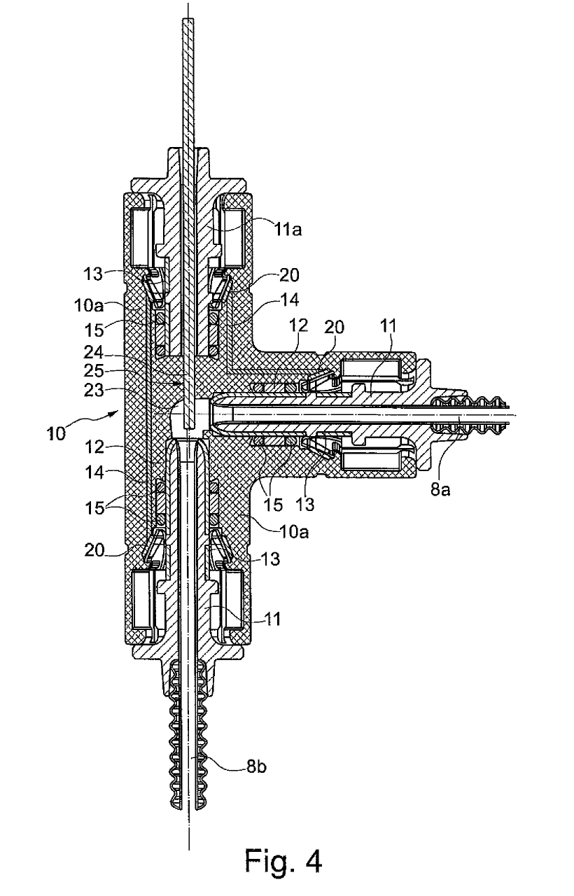

FIG. 4 shows another embodiment of a plug-in connection 10, 11 of a urea supply system 2 for a waste gas cleaning catalyst 1 of a motor vehicle. Similar to the embodiments illustrated in FIGS. 2 and 3, the plug-in connection is formed by a female connector 10 and matching male connectors 11. In the embodiment illustrated in FIG. 4, the plastic body 10a of the female connector 10 has three connection apertures suitable for receiving a male connector 11 of the plug-in connection. Two of these connection apertures are connected to each other by means of a fluid channel 23 and intended for the receiving a fluid-conveying male connector 11, e.g., for the connecting to a fluid duct section 8a, 8b, to a pump or to another fluid-conveying component of a urea supply system. The third aperture is connected via a second channel 24a to the fluid channel 23 that connects the two other connection apertures. The third connection aperture serves therefore not for receiving a fluid-conveying male connector 11 but rather for a connecting piece 11a with an electric component 24 extending via the second channel 25 into the fluid channel 23.

This component 24 can be a probe, e.g., a temperature and/or pressure sensor. It is also possible that the component 24 is configured as a heating rod that heats the fluid channel 23. The heating rod may be the only heating means of the connection or an additional heating means. Such a heating rod 24 can be longer than illustrated in FIG. 4 and it can also extend up to a male connector 11 protruding into the fluid channel 23, thus heating also the fluid in an inserted male connector 11.

The second channel 25 is preferably narrower than the fluid channel 23. Preferably, the outer diameter of the electric component 24 corresponds to the inside diameter of the second channel 25, as it is the case in the embodiment illustrated in FIG. 4, so that penetration of fluid into the second channel 25 is inhibited.

To establish an electric contact of a male connector 11a inserted into the third aperture, the plastic body 10a is provided with another electric contact area 20 that is connected to the electric connection line 14 which is supported by the plastic body 10a and during operation conveys a heating current for the heating of the fluid duct 8a, 8b connected to the female connector 10. In such a manner, the electric connection line 12, 13, 14 of the plug-in connection and also the heating of the heating system of the urea supply system can be very easily connected to a supply line and, thus, also to the electrical system of a motor vehicle, since a male connector 11, not conveying a fluid, inserted into the third aperture can be used for this purpose. As in the case of the two other connection apertures, sealing elements 15, constituted by O-rings, are provided so that no urea solution can flow out of the third aperture.

If, as preferred, the female connector 10 has three connection apertures of the same dimensions into each of which male connectors 11, 11a can engage mechanically in the same manner, manufacturing costs can be reduced since, in spite of the different functions of the individual connection apertures, as regards mechanics and sealing, like components can be used.

In the embodiment illustrated in FIG. 4 male connectors 11 are inserted into each of the two connection apertures connected by the fluid channel 23. The mate connectors 11 are attached to the ends of the heated fluid duct sections 8a, 8b.

However, according to FIG. 3, it is also easily possible to configure one of these connection apertures so as to be connected to a metering valve, a pump, a tank, or to other components of the urea supply system. The male connectors 11 of such components of a urea supply system are often not provided with a heating system. In such cases it is advantageous to use the probe channel for a heating rod 24 that extends as far as to the connecting piece 11 inserted into the fluid channel 23. Thus the heating rod 24 may be markedly longer than illustrated in FIG. 4.

The plug-in connections illustrated in FIGS. 2 to 4 are merely examples of embodiments of the invention that do not delimit the area of protection of the patent. Other embodiments of the plug-in connection according to the invention are also possible. Thus, in the case of plug-in connections that connect two fluid duct sections 8a and 8b to each other, the arrangement made can not only be such that the two fluid duct sections 8a, 8b are connected to each other at right angles. The fluid duct sections 8a and 8b and with them the connection apertures into which they are inserted can be arranged at any other angles in the female connector 10, especially aligned to each other at an 180° angle.

As an alternative, the plug-in connection according to the invention can be configured in such a manner that, e.g., it not only connects two fluid duct sections 8a and 8b but more than two of such fluid duct sections, e.g., three or four fluid duct sections. By way of example, three fluid duct sections can be arranged in a T-shaped manner in the plug-in connection so that all three are in contact with each other. The electric heating of the three fluid duct sections can be effectuated separately; but it can also be combined by the three fluid duct sections having, e.g., a common electric terminal post in the center of the plug-in connection. Such a post can be connected to a positive pole of the electrical system of the vehicle, while the ends of the three fluid duct sections distant from the plug-in connections may be connected to ground, eventually by inserting another fluid duct section. A sensor, e.g., a temperature or a pressure sensor can be incorporated into one of the male connectors 11 for a fluid duct section and extend up to the fluid channel 23 positioned in the center of the plug-on connection.

However, it is also possible to add at least one plug-in slot to a plug-in connection for, e.g., three fluid duct sections, into which can be plugged in a male connector 11a with an electric component 24 that, e.g., could be either a sensor probe for pressure or temperature or a heating rod. For this purpose, the plug-in connection can be cruciform, e.g., in the manner that, originating from the plug-in connection illustrated in FIG. 4 opposite of the plug-in slot for the fluid duct section 8a, is arranged a similar plug-in slot for a third fluid duct section.

In the case of an, e.g., star-shaped arrangement it is possible that a plug-in connection comprises more than four plug-in slots. By way of example, four plug-in slots for the connecting of four fluid duct sections can be arranged cross-shaped in a plane while, e.g., one or two other plug-in slots, for the inserting of a male connector 11a for one or two electric components 24, can be arranged vertically to the plane of the four fluid duct sections.

### REFERENCE NUMBERS LIST

1 Waste gas cleaning catalyst

2 Reductant supply system

3 Reductant tank

4 Urea solution

5 Pump

6 Fluid duct

7 Outlet

8 Fluid duct

8a Fluid duct section

8b Fluid duct section

9 Control unit

10 female connector

10a Plastic body

11 Male connector

11a Male connector for a probe 24 or for a heating rod 24

12 Metal sleeve

13 Spring element

14 Heating coil

15 O-ring

16 Heat insulator

17 Plastic element of the connecting piece 11

18 Latch of the plastic element 17

19 Pocket

20 Metal ring

21 Connecting piece

22 Insulation sheath

23 Fluid channel

24 Electric component, e.g., a probe or heating rod

25 Second channel

What is claimed is:

1. A reductant supply system for a waste gas cleaning catalyst of an internal combustion engine, comprising
a reductant tank for the storage of reductant,
at least one electrically heatable fluid duct for the conveyance of reductant from the reductant tank to a waste gas cleaning catalyst,
a pump to pump reductant via the fluid duct from the reductant tank to the waste gas cleaning catalyst, and
a plug-in connection for connecting sections of the fluid duct in a fluid-conveying manner and/or for connecting the fluid duct in a fluid-conveying manner to a component of the reductant supply system, whereby the plug-in connection forms an electric connection line that in operation conveys an electric heating current for the heating of the fluid duct.

2. A reductant supply system according to claim 1, wherein the plug-in connection comprises a female connector and at least one male connector inserted into the female connector, wherein the female connector has a plastic body through which runs at least one fluid channel and which carries a section of the electric connection line.

3. A reductant supply system according to claim 1, wherein at last a section of the fluid duct is provided as a corrosion-resistant metal pipe that contacts the electric connection line of the plug-in connection.

4. A reductant supply system according to claim 2, wherein the line section of the electric connection line, supported by the female connector, is made out of a synthetic material that, by electrically conductive admixtures was made electrically conductive.

5. A reductant supply system according to claim 2, wherein the coupling is heatable.

6. A reductant supply system according to claim 5, wherein the line section of the electric connection line, supported by the female connector, is configured for electric resistance heating.

7. A reductant supply system according to claim 6, wherein the heating of the plug-in connection and the heating of the fluid duct are effectuated by a series connection.

8. A reductant supply system according to claim 1, wherein the plug-in connection is enclosed by a heat insulator.

9. A reductant supply system according to claim 1, wherein the female connector is configured at least at two ends for the insertion of a male connector.

10. A reductant supply system according to claim 1, wherein the female connector of the plug-in connection interlocks with an inserted male connector.

11. A reductant supply system according to claim 1, wherein the female connector is provided with at least one O-ring that encloses an inserted male connector of the plug-in connection.

12. A reductant supply system according to claim 1, wherein the male connector of the plug-in connection is provided on its outside with a metal sleeve that constitutes a section of the electric connection line of the plug-in connection.

13. A reductant supply system according to claim 12, wherein the metal sleeve sits on a plastic body of the male connector.

14. A reductant supply system according to claim 12, wherein the metal sleeve is bonded with a metal pipe forming a section of the fluid duct.

15. A reductant supply system according to claim 12, wherein the metal sleeve enters only with its front end into electric contact with the fluid duct section configured as a metal pipe.

16. A reductant supply system according claim 1, wherein the male connector of the plug-in connection is electrically contacted by a metal spring element.

17. A reductant supply system according to claim 1, wherein the male connector of the plug-in connection encloses an end of the fluid duct section.

18. A reductant supply system according to claim 2, wherein the female connector has three plug-in slots for a male connector of the plug-in connection.

19. A reductant supply system according to claim 18, wherein a male connector with a rod shaped electric component is inserted in at least one plug-in slot while fluid conducting male connectors are inserted into the other plug-in slots.

20. A reductant supply system according to claim 18, wherein the fluid conducting male connectors are inserted only into two of three plug-in slots while into the third plug-in slot is inserted a male connector that connects the connection line of the plug-in connection to an electric power source.

21. A reductant supply system according to claim 18, wherein into one of the three plug-in slots is inserted a male connector that is provided with a probe or a heating rod, that extends into the fluid channel that connects the two other plug-in slots into which are inserted fluid-conveying male connectors.

22. A female connector for a plug-in connection for connecting a heatable fluid duct section, the female connector comprising:
a plastic body with a fluid channel for insertion of a male connector of the plug-in connection; and
an electric contact for contacting a power supply line of the male connector, the contact being connected to an electric connection line carried by the plastic body for conveying an electric heating current for the heating of at least one fluid duct section connected to the female connector.

23. The female connector according to claim 22, wherein the connection line is adapted for resistance heating.

24. A male connector of a plug-in connection for connecting of heatable fluid duct section, the male connector comprising a metal sleeve for enclosing an end of a fluid duct section, the metal sleeve contacting a section of an electric connection line of a matching female connector.

25. A male connector according to claim 24, wherein the metal sleeve encloses an end of a fluid duct section that is configured as a metal pipe which is in electric contact with the metal sleeve.
